(19) United States
(12) Patent Application Publication
(10) Pub. No.: US 2005/0281938 A1
(43) Pub. Date: Dec. 22, 2005

(54) Sterile dehulled soybean and method for producing sterile full fat soy flour

(75) Inventor: Hiroshi Harada, Saitama (JP)

Correspondence Address: RANKIN, HILL, PORTER & CLARK LLP, 4080 ERIE STREET, WILLOUGHBY, OH, 44094-7836, US

(73) Assignee: Pelican Co., Ltd., Saitama (JP)

(21) Appl. No.: 10/540,592

(22) PCT Filed: Dec. 27, 2002
(86) PCT No.: PCT/JP02/13779

§ 371 Date: Jul. 15, 2005

(51) Int. Cl. A23K 1/00

(52) U.S. Cl. 426/615

(57) ABSTRACT

There are provided sterile dehulled soybeans bearing bacteria of 300 cells/g or less, and a method for producing efficiently sterilized full fat soy flour using the sterile dehulled soybeans. The full fat soy flour is classified into three kinds: the first one in which deodorization is carried out without damaging available ingredients characteristic of soybeans such as water-soluble proteins and digestion and absorption efficiency is high due to inactivation of a digestion inhibiting enzyme; the second one in which enzymes are alive; and the third one in which all enzymes are inactivated. The method comprises: (a) a sorting step where foreign matters are removed from starting soybeans to obtain sorted soybeans; (b) a dehulling step where germs and hulls are removed from the sorted soybeans to obtain sterile dehulled soybeans; (c) a partially-inactivating steaming step where the sterile dehulled soybeans are steamed for 60 to 300 seconds by hot water or steam heated at a temperature of 70 to 125° C. so as to deodorize the sterile dehulled soybeans and inactivate a digestion inhibiting enzyme; (d) a desiccating step where the steamed sterile dehulled soybeans are desiccated to a predetermined water content; (e) a pulverizing step where the desiccated sterile dehulled soybeans are pulverized; and (f) a classifying step where the pulverized sterile dehulled soybeans are classified into only soy flour having a predetermined grain size or less.

### TECHNICAL FIELD

The present invention relates to sterile dehulled soybeans and methods for producing sterile full fat soy flour using the sterile dehulled soybeans, and more particularly to sterile dehulled soybeans bearing bacteria of 300 cells/g or less, a method for producing sterile full fat raw soy flour taking advantage of enzymes of soybean, a method for producing sterile full fat partially-inactivated soy flour in which deodorization and inactivation of a digestion inhibiting enzyme are effected without causing impairment of water-soluble proteins, and a method for producing sterile full fat fully-inactivated soy flour in which deodorization and inactivation of all enzymes are effected.

### BACKGROUND ART

As a conventional method for producing full fat soy flour, for example, there is known a method in which dehulled and roughly split cotyledons are subjected to heat treatment by steam of 100 to 120° C. for deodorization, followed by pulverization (JP-B 48-19946); a method in which dehulled soybeans are subjected to heat treatment by superheated steam of 130 to 190° C. under pressure for deodorization, followed by pulverization (JP-B 62-17505), or a method in which dehulled soybeans are subjected to heat treatment by heated steam and rough pulverization under heated dry air, followed by fine pulverization (JP-B 3-58263).

In these conventional methods for producing full fat soy flour, heating at high temperatures of 100° C. or more by steam is carried out for the purpose of inactivation of various enzymes, deodorization and sterilization. However, such heat treatment by steam of high temperature leads to drawbacks in that high-quality water-soluble proteins, minerals such as calcium, vitamins such as vitamin B₆ among active ingredients possessed by soybeans are denatured by such intense heat and hence they are difficult to be digested and absorbed.

Also, a lot of contaminating bacteria adhere to the partly remaining hulls, and it has been difficult to continuously produce sterile soybeans bearing bacteria of 300 cells/g or less.

Further, there is on the market soy flour that is produced by pulverizing raw soybeans without performing heat treatment by steam. However, such full fat soy flour is not subjected to heat treatment at high temperature, so that enzymes therein are not inactivated, deodorization is not achieved, and sterilization is insufficient. Therefore, it still has grassy smelling characteristic of soybeans, and is not suited for eating and drinking as it is. Accordingly, it is the present state of the art that it is used as raw materials for processed foods such as bean curds.

It is desired to produce soy flour which bears reduced number of bacteria compared to conventional one from the view point of health, and soy flour wherein denaturation of active ingredients (nutrition components) characteristic of soybeans such as water-soluble proteins is diminished as much as possible to achieve excellent digestion and absorption from the view point of nutrition.

The present invention has been made in consideration of the above problems in association with methods for producing conventional full fat soy flour, and it is an object of the present invention to provide a sterile dehulled soybean bearing bacteria of 300 cells/g or less, to provide a method for producing full fat soy flour using the sterile dehulled soybean, wherein without deteriorating available ingredients (nutrient composition) possessed by soybeans such as water-soluble proteins, grassy smelling characteristic of soybeans is removed (deodorized), and the full fat soy flour has a high rate in digestion and absorption by keeping digestion inhibiting enzymes inactive and is sufficiently sterilized, to provide a method for producing full fat soy flour which is sufficiently sterilized while keeping enzymes alive, and to provide a method for producing full fat soy flour which is sufficiently sterilized while keeping all enzymes inactive.

### DISCLOSURE OF THE INVENTION

In order to solve the above problems, a sterile dehulled soybean of the present invention is produced so as to bear bacteria of 300 cells/g or less by using a method for separating whole soybeans into cotyledons, germs and hulls, the method comprising: a heating step where sorted soybeans are softened by heating the sorted soybeans at a soybean temperature of 40 to 120° C.; an auxiliary dehulling step where cracks are generated on hulls of soybeans by sliding the hull of the soybean; a dehulling step where the soybeans are dehulled; an air sorting step where the hulls dehulled in the dehulling step are removed; a first sieving step where a soybean mixture resulting from the air sorting step is separated into undehulled whole soybeans and a mixture of half-split cotyledons and germs; a second sieving step where the mixture of half-split cotyledons and germs is separated into cotyledons and germs; a cooling step where the cotyledons separated in the second sieving step are cooled; and an additional dehulling step where the cooled cotyledons are dehulled.

A first aspect of a method for producing full fat soy flour of the present invention, namely, a method for producing full fat partially-inactivated soy flour comprises: (a) a sorting step where foreign matters are removed from starting soybeans to obtain sorted soybeans; (b) a dehulling step where germs and hulls are removed from the sorted soybeans to obtain sterile dehulled soybeans; (c) a partially-inactivating steaming step where the sterile dehulled soybeans are steamed for 60 to 300 seconds by hot water or steam heated at a temperature of 70 to 125° C. so as to deodorize the sterile dehulled soybeans and inactivate a digestion inhibiting enzyme; (d) a desiccating step where the steamed sterile dehulled soybeans are desiccated to a predetermined water content; (e) a pulverizing step where the desiccated sterile dehulled soybeans are pulverized; and (f) a classifying step where the pulverized sterile dehulled soybeans are classified into only soy flour having a predetermined grain size or less.

A second aspect of a method for producing full fat soy flour of the present invention, namely, a method for producing full fat raw soy flour comprises: (a) a sorting step where foreign matters are removed from starting soybeans to obtain sorted soybeans; (b) a dehulling step where germs and hulls are removed from the sorted soybeans to obtain sterile dehulled soybeans; (d) a desiccating step where the steamed sterile dehulled soybeans are desiccated to a predetermined water content; (e) a pulverizing step where the desiccated sterile dehulled soybeans are pulverized; and (f) a classifying step where the pulverized sterile dehulled soybeans are classified into only soy flour having a predetermined grain size or less.

A third aspect of a method for producing full fat soy flour of the present invention, namely a method for producing full fat fully-inactivated soy flour comprises: (a) a sorting step where foreign matters are removed from starting soybeans to obtain sorted soybeans; (b) a dehulling step where germs and hulls are removed from the sorted soybeans to obtain sterile dehulled soybeans; (c1) a fully-inactivating steaming step where the sterile dehulled soybeans are steamed for 60 to 300 seconds by hot water or steam heated at a temperature of 85 to 150° C. so as to deodorize the sterile dehulled soybeans and inactivate all enzymes; (d) a desiccating step where the steamed sterile dehulled soybeans are desiccated to a predetermined water content; (e) a pulverizing step where the desiccated sterile dehulled soybeans are pulverized; and (f) a classifying step where the pulverized sterile dehulled soybeans are classified into only soy flour having a predetermined grain size or less.

The present inventor found that the above method for separating whole soybeans into cotyledons, germs and hulls is very effective for production of sterile dehulled soybeans and sterile dehulled soy flour, and accomplished the present invention.

### BRIEF DESCRIPTION OF THE DRAWINGS

FIG. 1 is a flow chart showing an overall process of a method for producing full fat soy flour according to the present invention.

FIG. 2 is a flow chart showing a sorting step in the method for producing full fat soy flour according to the present invention.

FIG. 3 is a flow chart showing a dehulling step in the method for producing full fat soy flour according to the present invention.

### BEST MODE FOR CARRYING OUT THE INVENTION

Although a method for producing full fat partially inactivated soy flour according to the present invention will be given, it goes without saying that the following explanation is given for exemplification but not for restriction.

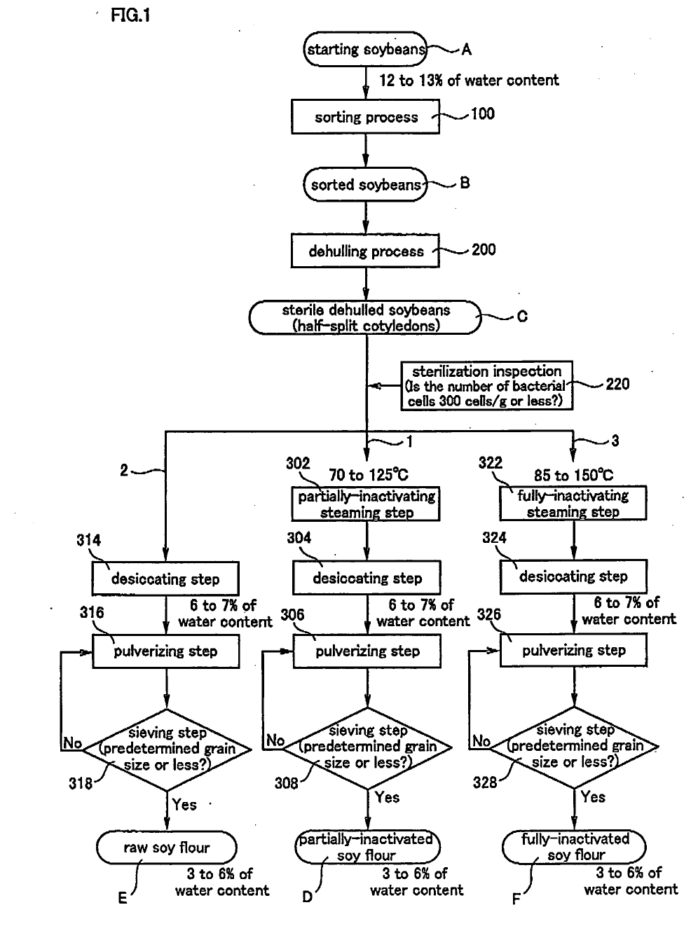

In FIG. 1, reference symbol (A) denotes starting soybeans, and reference numeral 100 denotes a sorting process. The sorting process 100 includes: a rough sorting step of removing foreign substances that are larger or smaller than soybeans from starting soybeans (A); an air sorting step of removing foreign substances that are lighter than soybeans; a stone removing step of removing foreign matters that are heavier than soybeans; and a roller sorting step of removing foreign matters that have similar sizes to soybeans but different shapes from them, and detail description thereof will be given later. Through the sorting process 100, it is possible to obtain sorted soybeans (B) where foreign matters contained in the starting soybeans (A) are fully removed. In general, the starting soybeans (A) contain 12 to 13% of water content.

Reference numeral 200 denotes a dehulling process. The dehulling process includes: a heating step of heating the sorted soybeans B sorted in the sorting step 100 at a soybean temperature of 40 to 120 degrees to soften the soybeans; an auxiliary dehulling step of generating cracks on hulls of soybeans by sliding the hulls of the soybeans; a dehulling step of dehulling the soybeans; an air sorting step of removing the hulls dehulled in the dehulling step; a first sieving step of separating a soybean mixture resulting from the air sorting process into undehulled whole soybeans and a mixture of half-split cotyledons and germs; a second sieving step of separating the mixture of half-split cotyledons and germs into cotyledons and germs; a cooling step of cooling the cotyledons separated in the second sieving step; and an additional dehulling step of dehulling the cooled cotyledons, whereby the half-split cotyledons are rendered dehulled soybeans through the additional dehulling step. The dehulling process 200 affords sterile dehulled soybeans (C) that are fully dehulled and half-split cotyledons obtained from the sorted soybeans (B).

Sterilization inspection 220 is performed on predetermined lot units of the sterile dehulled soybeans (C) according to sampling inspection. In the sterilization inspection 220, the number of bacterial cells is counted according to the “Guideline of Food and Health Inspection” (The Life and Health Division of The Welfare Ministry), and it is confirmingly inspected that the number of bacterial cells of the sterile dehulled soybeans C is 300 cells/g or less. The lot having the number of bacteria cells of 300 cells/g or more is processed again or discarded.

The sorting step 100, the dehulling step 200 and the sterilization inspection 220 are common in first to third aspects of the method for producing full fat soy flour of the present invention which will be described below, and are performed in similar manners in any aspects of the present method. However, each of the subsequent steps differs from each other depending on the kind of full fat soy flour to be produced, that is, full fat partially-inactivated soy flour (D), full fat raw soy flour (E) and full fat fully-inactivated soy flour (F).

The first aspect of the method for producing full fat soy flour according to the present invention is, in short, a method for producing the full fat partially-inactivated soy flour (D) and the method has a production process denoted by reference numeral 1.

To be more specific, in the process 1 for producing the full fat partially-inactivated soy flour (D), as shown in the drawing, the starting soybeans (A) are sequentially subjected to the sorting step 100, the dehulling step 200, a partially-inactivating steaming step 302, a desiccating step 304, a pulverizing step 306 and a sieving step 308, whereby the starting soybeans (A) are processed into the full fat partially-inactivated soy flour (D).

The partially-inactivating steaming step 302 is provided for inactivation of trypsin inhibitor which is a digestion inhibiting enzyme in the sterile dehulled soybeans (C) and deodorization therefor. The partially-inactivating steaming step 302 can be achieved by using a known deodorizer (also referred to as a continuous steaming furnace). Steaming in the partially-inactivating steaming step 302 is conducted at a relatively low temperature by hot water or steam in the temperature range of 70 to 125° C., preferably 86 to 105° C. for 60 to 300 seconds. Below this temperature range, the digestion inhibiting enzyme (trypsin inhibitor) will not be inactivated, and deodorization is insufficient. Contrarily, if the temperature exceeds the above range, available ingredients (nutrition composition) characteristic of soybeans such as high-quality water-soluble proteins and the like are denatured, to impair the efficiency of digestion and absorption.

In the desiccating step 304, the dehulled soybeans (C2) subjected to inactivation of the digestion inhibiting enzyme and deodorization in the above partially-inactivating steaming step 302 are desiccated to the water content of 7 wt % or less, for example, about 6 to 7 wt %. The desiccating step 304 can be achieved by using a known desiccator.

The pulverizing step 306 is provided for pulverizing the sterile dehulled soybean (C) desiccated in the desiccating step 304 in a sterile condition. This pulverizing step 306 can be achieved by using a known pulverizer.

Pulverizing in the pulverizing step 306 is preferably conducted in two stages: rough pulverizing and fine pulverizing. If fine pulverizing is performed from the beginning, there is higher the heat generation during pulverizing, so that available ingredients (nutrition composition) characteristic of soybeans such as high-quality water-soluble proteins may denature. Therefore, after the soybeans are roughly pulverized into grain sizes of about 20 to 40 meshes, fine pulverizing for achieving a grain size of 100 to 1000 meshes may be conducted to reduce the heat generation during pulverizing to the low levels.

In the pulverizing step 306, the pulverizing may be conducted in a sterile condition. This serves to prevent contaminating bacteria from adhering again to the sterile dehulled soybeans (C) because the interior of the pulverizer is susceptible to proliferation of contaminating bacteria due to a remaining trace amount of soy flour. For example, the heating sterilization may be achieved by causing hot air of 60° C. or higher to communicate in the interior of the pulverizer where the pulverizing step 306 is conducted, using a hot air desiccating machine such as AEROFIN HEATER.

In the sieving step 308, the sterile dehulled soybeans (C) pulverized in the pulverizing step 306 are sieved to only soy flour having grain sizes each of a predetermined grain size or less. This sieving step 308 can be achieved by using a known sieving machine. In the sieving step 308, soy flour having grain sizes each larger than the predetermined grain size are again put into the pulverizing step 306 and pulverized, which makes it possible to obtain soy flour having grain sizes each of the predetermined grain size or less without waste.

The full fat partially-inactivated soy flour (D) obtained in this manner is easy to eat because the digestion inhibiting enzyme (trypsin inhibitor) is inactivated, and denaturation of available ingredients (nutrition composition) possessed by soybeans is reduced, digestion and absorption is improved, and deodorization is effected. The full fat partially-inactivated soy flour (D) is hygienically favorable because sufficient sterilization is effected. The full fat partially-inactivated soy flour (D) is especially suited for drinking use, and is useful as a casual soybean beverage when dissolved in drinking water.

Next, the second aspect of the method for producing full fat soy flour according to the present invention is, in short, a method for producing the full fat raw soy flour (E) and the method has a production process denoted by reference numeral 2.

To be more specific, in the process 2 for producing the full fat raw soy flour (E), as shown in the drawing, the starting soybeans (A) are sequentially subjected to the sorting step 100, the dehulling step 200, a desiccating step 314, a pulverizing step 316 and a sieving step 318, whereby the starting soybeans (A) are processed into the full fat raw soy flour (E).

The sorting step 100 and the dehulling step 200 are common to those of the first aspect of the method for producing full fat soy flour according to the present invention, and detailed description thereof will be given later. Also the sterilization inspection 220 is similar to that of the aforementioned process 1 for producing the full fat partially-inactivated soy flour D (the first aspect of the method for producing full fat soy flour), and repetition of the explanation will be omitted.

A significant difference between the process 2 for producing the full fat raw soy flour (E) and the process 1 for producing the full fat partially-inactivated soy flour (D) (the first aspect of the method for producing the full fat soy flour of the present invention) described above is that a step corresponding to the partially-inactivating steaming step 302 is not carried out.

In the case of the full fat raw soy flour (E), steaming will impair characteristics of the raw soy flour. Therefore, all enzymes that are possessed by soybeans are not inactivated, and deodorization is not effected. 1

The desiccating step 314, the pulverizing step 316 and the sieving step 318 are respectively similar to the desiccating step 304, the pulverizing step 306 and the sieving step 308 described above, and hence repetition of the explanation will be omitted.

The full fat raw flour (E) thus obtained is accompanied with no denaturation of available ingredients (nutrition composition) possessed by soybeans. Since enzymes are not inactivated, they can be suitably used as ingredients for processed foods such as bean curd, bread, and pasta. Also in this case, the full fat raw soy flour (E) is sufficiently sterilized, so that the processed foods using the full fat raw soy flour (E) keeps good for a long time.

Next, the third aspect of the method for producing full fat soy flour of the present invention is, in brief, a method for producing full fat fully-inactivated soy flour (F), and includes the production process denoted by reference numeral 3.

To be more specific, in the process 3 for producing the full fat fully-inactivated soy flour (F), as shown in the drawing, the starting soybeans (A) are sequentially subjected to the sorting step 100, the dehulling step 200, a fully-inactivating steaming step 322, a desiccating step 324, a pulverizing step 326 and a sieving step 328, whereby the starting soybeans (A) are processed into the full fat fully-inactivated soy flour (F).

The sorting step 100 and the dehulling step 200 are common to those of the first aspect of the method for producing full fat soy flour according to the present invention, and detailed description thereof will be given later. Also the sterilization inspection 220 is similar to that of the aforementioned process 1 for producing the full fat partially-inactivated soy flour (D) (the first aspect of the method for producing full fat soy flour), and repetition of the explanation will be omitted.

A significant difference between the process 3 of producing the full fat fully-inactivated soy flour (F) and the process 1 of producing the full fat partially-inactivated soy flour (D) (the first aspect of the method for producing the full fat soy flour of the present invention) described above is that the fully-inactivating steaming step 322 is adopted in place of the partially-inactivating steaming step 302, and the steaming is effected at a relatively high temperature range so as to inactivate all enzymes in soybeans.

The fully-inactivating steaming step 322 is provided for inactivation of all enzymes such as trypsin inhibitor, lipoxygenase and the like in the sterile dehulled soybeans (C), and deodorization thereof. The fully-inactivating steaming step 322 can be achieved by using a known deodorizer (also referred to as a continuous steaming furnace). Steaming in the fully-inactivating steaming step 322 is conducted at a relatively high temperature by hot water or steam in the temperature range of 85 to 150° C., preferably 105 to 135° C. for 60 to 300 seconds. Below this temperature range, all enzymes are not inactivated, while above this temperature range, available ingredients (nutrition composition) possessed by soybeans are dramatically denatured.

The desiccating step 324, the pulverizing step 326 and the sieving step 328 are respectively similar to the desiccating step 304, the pulverizing step 306 and the sieving step 308 in the aforementioned process 1 of producing the full fat partially-inactivated soy flour (D), and hence repetition of the explanation will be omitted.

The full fat fully-inactivated soybeans (F) have utility as a convenient food material having broad applicability because all enzymes are inactivated and deodorization is adequately effected.

Next, explanation will be made on the sorting step 100 and the dehulling step 200 commonly applied in the first to third aspects of the method for producing full fat soy flour of the present invention as describe above.

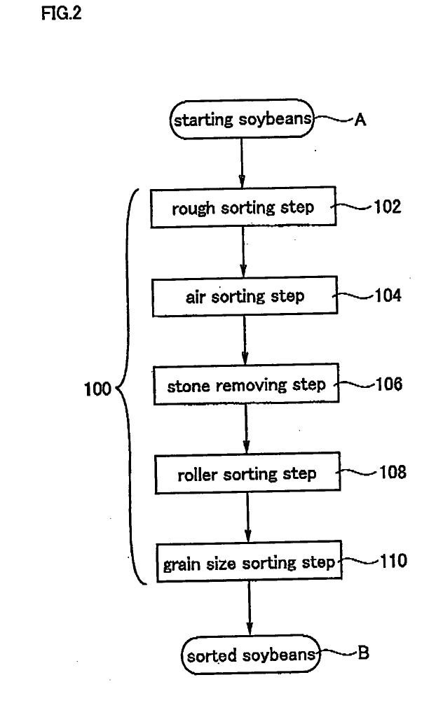

In FIG. 2, reference numeral 100 denotes a sorting step. The sorting step 100 includes a rough sorting step 102, an air sorting step 104, a stone removing step 106 and a roller sorting step 108. Reference numeral (A) denotes starting soybeans that are raw whole soybeans not subjected to any processing and sorting.

The rough sorting step 102 is a step for sorting and removing foreign matters that have different grain sizes from the starting soybeans (A), which can be achieved by using a known rough sorting machine. A rough sorting machine sorts and removes foreign matters having larger grain sizes (corns, mud mass, stones and the like) and foreign matters having smaller grain sizes (seeds, grass seeds, pebbles and the like) by sieving in such a manner that punching plates of different two stages vibrate so that those having larger grain sizes than the soybeans remain on the upper punching plate, those having the same grain size as the soybeans remain on the lower punching plate, and those having smaller grain sizes than the soybeans drop down through the lower punching plate. As a result, it is possible to remove the foreign matters having larger or smaller grain sizes than the soybeans.

The air sorting step 104 is a step for sorting and removing foreign matters of light weight from the starting soybeans (A), and can be carried out using a known air sorting machine (a suction air force sorting machine, also referred to as a gravity separator). An air sorting machine (a suction air force sorting machine, a gravity separator) sorts and removes foreign matters of light weight (dirt, hulls, small dusts and the like) by means of suction air force. This enables foreign matters having light weight than the soybeans to be removed. Sorting by the air sorting step 104 may be conducted prior to the rough sorting step 102.

The stone removing step 106 is a step for removing stones from the starting soybeans (A), and can be achieved by using a known stone removing machine. A stone removing machine sorts and removes stones by causing a sorting porous plate inclined in one direction to vibrate while blowing air from below the plate, and allowing only heavy stones to drift toward an inclined upper part of the sorting porous plate. As a result, it is possible to remove foreign matters such as stores that are heavier than the soybeans. Sorting by the stone removing machine 106 may be carried out only when the starting soybeans (A) are contaminated stones, and when it is clear that no stones are included, it may be omitted.

The roller sorting step 108 is provided for sorting and removing foreign matters that have different shapes from the soybeans (unrotatable foreign matters of flat form, angular form, irregular circular form and the like), and can be achieved by using a known roller sorting machine. A roller sorting machine includes a lower roller; an upper roller disposed diagonally above the lower roller; an endless belt laid across the upper roller and the lower roller; at least one saw tooth plate on a top face of the endless belt; and an elongated slope discharge plate inclined laterally downward in a lateral end part on the lower inclining side of the endless belt for allowing rotation of the endless belt toward the upper roller. The lower roller and the upper roller are inclined in the same direction at respective predetermined angles, and the inclination angle of the lower roller is smaller than the upper roller. With this structure, rotatable circular form matters (soybeans) rotate to drop lateral lower side, while unrotatable irregular foreign matters are fed toward the upper roller without rotation, whereby foreign matters of irregular shapes can be sorted and removed. In this manner, foreign matters having similar gravities to the soybeans but different shapes therefrom can be removed.

Almost all of the foreign matters can be removed from the starting soybeans (A) through the steps up to the roller sorting step 108. Accuracy of dehulling in the subsequent dehulling step 200 is not improved unless grain sizes of the soybeans are uniform. For addressing this problem, a grain size sorting step 110 is conducted for further sorting the starting soybeans (A) according to the grain size, and equalizing the grain sizes, whereby the starting soybeans (A) are sorted into “large grains”, “middle grains” and “small grains”, for example. The grain size sorting step 110 can be conducted using a known grain size sorting machine. The grain size sorting machine sorts soybeans into large soybeans, middle soybeans and small soybeans by sieving in such a manner that punching plates of different two stages vibrate so that soybeans having large grain sizes remain on the upper punching plate, soybeans having middle grain sizes remain on the lower punching plate, and soybeans having small grain sizes drop down through the lower punching plate. Through this grain size sorting step 110, grain sizes of the starting soybeans (A) are equalized, and accuracy of dehulling in the subsequent dehulling step 200 improves.

Furthermore, in each of the above steps, a dirt collector for collecting generated dirt or dust may further be provided. Such a dirt collector collects fine dirt and dust, so that the quality of the sorted soybeans (B) is improved, and atmosphere of the working place is made clean.

When magnetic foreign matters such as metal substances are included in the starting soybeans (A), a magnetic power sorting step may be additionally conducted. The magnetic power sorting step can be achieved by using a known drum magnetic sorting machine. A drum magnetic sorting machine sorts and removes magnetic foreign matters such as metal substances by an absorbing action of a magnet disposed inside a rotation drum. This allows removal of magnetic foreign matters (nails, metal strips and the like).

In this manner, the starting soybeans (A) turn into the sorted soybeans (B) from which foreign matters are fully removed.

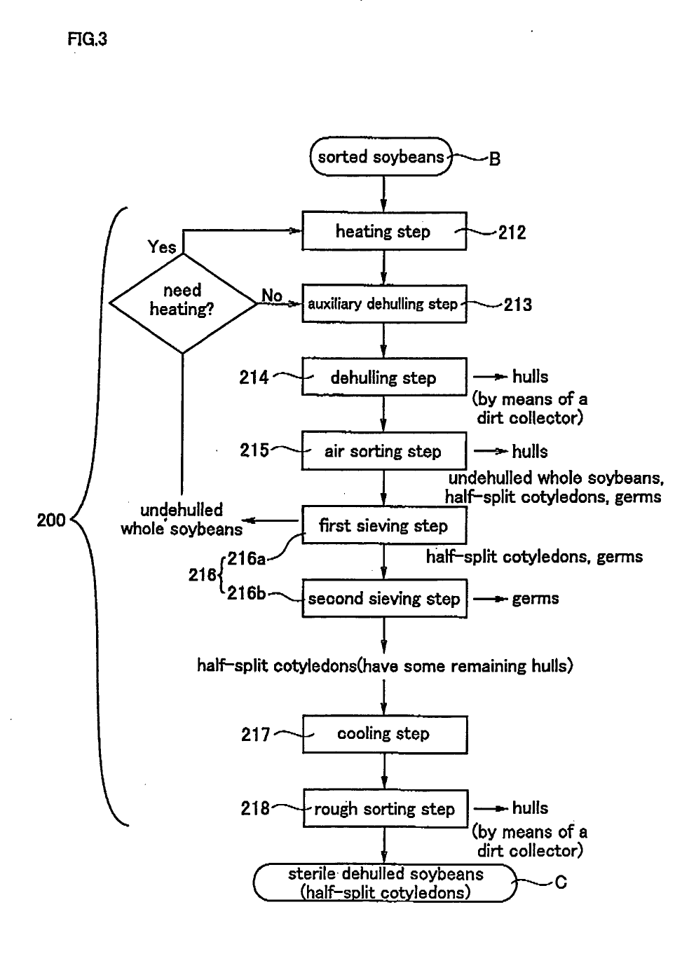

In FIG. 3, reference numeral 200 is a dehulling step. The sorted soybeans (B) are whole soybeans sorted through the above sorting step 100.

The heating step 212 is a step for softening the sorted soybeans (B) at an initial temperature of 40 to 120° C., and is conducted for softening the soybeans in order to prevent small cracking of the soybeans. The heating time is from a moment to about 20 minutes although it varies depending on the condition of the soybeans. The heating step 212 can be achieved by using a known heating machine.

The auxiliary dehulling step 213 is a step for making a crack in a hull of a soybean by sliding the hull of the soybean, and is conducted for the purpose of supporting the dehulling operation in the subsequent dehulling step 214. The auxiliary dehulling step 213 generates a crack by applying a stress on the soybean. The auxiliary dehulling step 213 can be achieved by using a known auxiliary dehulling machine. For the auxiliary dehulling machine, the one having a well-known structure, conventionally known as a husker is used with some modifications is used. The basic structure of the auxiliary dehulling machine has two rubber rollers provided at an interval and a hopper for introduction of raw materials. The two rubber roller rotating at different rotation speeds slide hulls of the introduced starting soybeans to generate cracks (breaks in hulls). Of course, some hulls are peeled off. The interval between these two rubber rollers is set so that a crack is favorably made in a soybean, and usually about 1 to 5 mm. The rotation speeds of the two rubber rollers are: about 750 to 850 rpm for one, and a difference between rotation speeds of two rubber rollers is preferably about 20%

The dehulling step 214 is for dehulling soybeans, and can be achieved by using a known dehulling machine. For the dehulling machine, the one having a well-known structure conventionally known as a polishing machine for polishing the surface of beans or the like is used with some modification. The basic structure of the dehulling machine includes a mesh-like drum having a plurality of rotating blades therein, disposed in a fixed state, and a hopper for introduction of raw materials. Starting soybeans introduced into the mesh-like drum, namely soybeans having cracks made by the auxiliary dehulling machine are fully dehulled through interaction between rotating blades and the mesh-like drum. At this time, rotation of the blades is adjusted so that the soybeans are not finely crushed. The dehulled soybeans, namely half-split soybeans (cotyledons) and germs, as well as hulls that are not removed by dirt collection as will be describe later move within the mesh-like drum and then discharged via a product outlet. Here, relatively large hulls which move through the mesh-like drum together with cotyledons and germs are collected in a different direction. The hulls dropped off the mesh-like drum and other foreign matters drop downward and are collected by another dirt collector. The rotation speeds of the plurality of blades are adjusted so that the soybeans are not finely crushed, and are usually preferably about 300 rpm/min.

The air sorting step 215 is provided for removing the hulls dehulled in the dehulling step, and can be conducted in a routine procedure using a known air sorting machine.

The sieving step 216 is provided for separating the air sorted soybean mixture into undehulled whole soybeans and half-split cotyledons. The term “soybean mixture” used herein encompasses whole soybeans not having been dehulled (undehulled whole soybeans) and cotyledons split into two cotyledons (half-split cotyledons). These should be further separated, and hence the sieving is conducted in two stages.

More specifically, in the first sieving step 216a, separation into undehulled whole soybeans, and a mixture of half-split cotyledons and germs is conducted by sieving. The undehulled whole soybeans may be returned to the heating step 212 or the auxiliary dehulling step 213. The decision as to which one of the heating step 212 and the auxiliary dehulling step 213 the undehulled whole soybeans should be returned to is made depending on whether or not the undehulled whole soybeans have been sufficiently heated by them. Practically, an operator at the work site judges on whether a further heat treatment is needed or not, and makes a decision on which step the soybeans should be returned to.

Next, in the second sieving step 216b, the mixture of half-split cotyledons and germs is sieved to separate from each other. Finely crushed cotyledons may also exist in the mixture, but they can be appropriately separated by sieving means when required.

The cooling step 217 is provided for cooling the half-split cotyledons that have been subjected to the sieving separation in the second sieving step 216b and have some remaining hulls. In this cooling step 217, the cotyledons expanded due to the heating process are allowed to contract by cooling with the cooling means, enabling a cotyledon and the hull to easily peel off. As the cooling means, a cooling tank that uses normal temperature air for cooling, but, other known cooling means can obviously be applied.

The additional dehulling step 218 is provided for conducting a dehulling treatment again on the cooled cotyledons. In this additional dehulling step 218, with respect to the half-split cotyledons having some remaining hull in which a cotyledon and the hull is easy to peel off as a result of the cooling treatment, there is carried out separation into half-split cotyledons and hulls. This additional dehulling step 218 can be achieved by using a dehulling machine similar to that used in the dehulling step 214. The cotyledons dehulled again turn to the sterile dehulled soybeans (C).

In this manner, through the dehulling step 200, the sorted soybeans (B) turn to the fully dehulled half-split cotyledons, namely, the sterile dehulled soybeans (C).

As the dehulling step 200, for example, a method for separating whole soybeans into cotyledons, germs and hulls disclosed in JP A No. 2001-17107 can be used desirably.

### EXAMPLES

Now, the present invention will be described with reference to Examples. These Examples are presented by way of exemplification but should not be construed by way of limitation.

### Example 1

First, the sorting step 100 was conducted in the following manner to obtain sorted soybeans (B) from starting soybeans (A).

From 100 kg of the starting soybeans (A), foreign matters larger than soybeans (corn, mud mass and the like) or foreign matters smaller than soybeans (grass seeds, morning glory seeds) were removed by means of a commercially available rough sorting machine (rough sorting step 102), light foreign matters (dirt, skin, small dust and the like) were removed by means of a commercially available gravity separator (air sorting step 104), foreign matters that are heavier than soybeans such as stones were removed by means of a commercially available stone removing machine (stone removing step 106), foreign matters having different shapes were removed by means of a commercially available roller sorting machine (roller sorting step 108), and the resultant soybeans were sorted according to the grain size by means of a commercially available grain size sorting machine (grain size sorting step 110).

Next, the dehulling step 200 was conducted in the following manner to obtain sterile dehulled soybeans (C).

After heating by hot air at a temperature of about 100° C. for about 5 minutes so that the temperature of the soybeans is about 60° C. (heating step 212), the heated soybeans were subjected to a commercially available auxiliary dehulling machine (an interval between two rubber rollers was 1 to 5 mm, and rotation speeds of the two rubber rollers were 809 rpm for one and 1050 rpm for the other, and a difference in rotation number of them was about 20%) to generate cracks on the soybeans (auxiliary dehulling step 213).

The soybeans having cracks were dehulled by means of a commercially available dehulling machine (rotation number of plurality of blades was 300 rpm) (dehulling step 214), and about half of the hulls dehulled was removed by means of a dirt collector. Using a commercially available air sorting machine, the remainder of dehulled hulls not removed by the dirt collector was removed by a commercially available air sorting machine (air sorting step 215).

The remaining soybean mixture after removal of the hulls was subjected to a commercially available multi-stage sieving apparatus to separate into cotyledons and germs (sieving step 216). To be more specific, the soybean mixture after the air sorting step was subjected to the first sieve to separate into whole soybeans not having been dehulled (undehulled whole soybeans) and a mixture of cotyledons split into two cotyledon (half-split cotyledons) and germs (first sieving step 216a), and then the mixture of cotyledons and germs was subjected to the second sieve to separate into half-split cotyledons and germs (second sieving step 216b).

Some hulls remained on these separated cotyledons. The separated cotyledons were cooled by room temperature air by means of a commercially available cooling tank (equipped with a cooling fan, the capacity of about 8 m³) (cooling step 217), and the cooled cotyledons were again subjected to dehulling by means of a commercially available dehulling machine, to remove the remaining hulls (additional dehulling step 218).

The resultant sterile dehulled soybeans (C) were inspected for the number of bacteria in accordance with the “Guideline of Food and Health Inspections” (The Life Health Division of The Welfare Ministry), and the number of bacteria was 300 cells/g or less (sterilization inspection 220).

As to the sterile dehulled soybeans (C), using a commercially available continuous steaming furnace, steaming was executed for 120 seconds by hot water of 90° C. (partially-inactivating steaming step 302).

The sterile dehulled soybeans (C) after steaming were dried to a water content of 6 wt % by using a commercially available desiccator (desiccating step 304).

Then, using a commercially available pulverizer that was preliminarily sterilized by heating under internal circulation of hot air by an AEROFFN HEATER, the dried sterile dehulled soybeans (C) were roughly pulverized at a grain size of 30 meshes, followed by fine pulverizing at a grain size of 600 meshes (pulverizing step 306).

Using a commercially available classifying machine, the obtained soy flour was classified so that it contained only grains having grain sizes of 600 meshes or less (classifying step 308). The resultant soy flour containing only grains having grain sizes of 600 meshes or more was put again into the pulverizing step 306.

Results of a componential analysis of the full fat partially-inactivated soy flour (D) obtained in this manner are shown in Table 1 and Table 2, and results of bacterial inspection are shown in Table 3.

TABLE 1

| Analytical test | | Detection | | Analytical |
|---|---|---|---|---|
| item | Results | limit | Notes | method |
| Water content | 3.6 g/100 g | | | Normal pressure |
| | | | | heating |
| | | | | desiccating |
| | | | | method |
| Protein | 38.9 g/100 g | | 1 | Kjeldahl method |
| Lipid | 28.6 g/100 g | | | Extraction with |
| | | | | Chloroform/ |
| | | | | methanol |
| | | | | mixture |
| Ash | 5.1 g/100 g | | | Direct ashing |
| | | | | method |
| Sugar | 12.7 g/100 g | | 2 | |
| Dietary fiber | 11.1 g/100 g | | | Oxygen-Weight |
| | | | | method |
| Energy | 464 kcal/100 g | | 3 | |

Notes:
1 Nitrogen-protein conversion factor: 5.71
2 Calculation formula according to the Nutrition labeling standard (Notice No. 146 from The Ministry of Welfare of Japan, 1996): 100 − (water + protein + lipid + ash + dietary fiber)
3 Energy conversion factor according to the Nutrition labeling standard (Notice No. 146 from The Ministry of Welfare of Japan, 1996): protein 4; lipid 9; sugar 4.

TABLE 2

| | | | |
|---|---|---|---|
| Vitamins | | Lipids | |
| Thiamine | 0.71 mg/100 g | Phospholipids | 1.50% |
| (Vitamin B1) | | (as stearo, oreo, lecithin) | |
| Riboflavin | 0.27 mg/100 g | | |
| (Vitamin B2) | | | |
| Vitamin B6 | 0.65 mg/100 g | Acid value | 1.23% |
| | | of extracted oil | |
| Total | 38.4 mg/100 g | Peroxide value | 15.4 meq/kg |
| tocopheral | | of extracted oil | |
| (Vitamin E) | | | |
| α-tocopherol | 2.2 mg/100 g | Oleic acid | 4.0% |
| β-tocopherol | 0.7 mg/100 g | Linoleic acid | 11.4% |
| γ-tocopherol | 22.6 mg/100 g | Linolenic acid | 2.2% |
| δtocopherol | 12.9 mg/100 g | Fatty acid composition | |

| | | | | | |
|---|---|---|---|---|---|
| Niacin | 1.95 mg/100 g | C16/0 | 11.2% | C18/2 | 53.5% |
| Minerals, | | C16/1 | 0.1% | C18/3 | 10.2% |
| Metals | | C17/0 | 0.1% | C2010 | 0.6% |
| Phosphorus | 568 mg/100 g | C17/1 | 0.1% | C20/1 | 0.2% |
| Iron | 5.82 mg/100 g | C18/0 | 4.0% | C22/0 | 0.4% |
| Calcium | 144 mg/100 g | C18/1 | 19.3% | Not | 0.3% |
| | | | | identified | |

| | | | |
|---|---|---|---|
| Sodium | 3.39 mg/100 g | Digestion rate | |
| Potassium | 1.85% | Pepsin digestion rate | 96.1% |
| Potassium | 235 mg/100 g | Pancreatin digestion rate | 87.1% |
| | | Amino nitrogen | 42 mg/100 g |
| | | Trypsin inhibitor activity | 20.2 TIU/mg |

TABLE 3
Hygienic inspection

| | |
|---|---|
| Arsenic | Not detected |
| General bacteria number | 300 cells/g or less |
| (viable count) | |
| Escherichia coli group | Negative/2.22 g |
| Staphylococcus aureus | Negative/0.01 g |
| Salmonellal | Negative/0.01 g |
| Yeast number | Negative/0.01 g |
| Heat resistant | 300 cells/g or less |
| sporeformer number | |
| Residual pesticide (gas chromatography) | |
| BHC | Not detected |
| | (detection limit: 0.1 ppm) |
| DDT | Not detected |
| | (detection limit: 0.1 ppm) |
| Diazinon | Not detected |
| | (detection limit: 0.05 ppm) |
| Parathion | Not detected |
| | (detection limit: 0.05 ppm) |
| Fenitrothion ( M E P ) | Not detected |
| | (detection limit: 0.05 ppm) |
| Malathion(Malathon) | Not detected |
| | (detection limit: 0.05 ppm) |

As shown in Table 1, denaturation of available ingredients (nutrition composition) possessed by soybeans was insignificant, and as shown in Table 2, activity of the trypsin inhibitor which is a digestion inhibiting enzyme was also suppressed to the lower level.

As shown in Table 3, the numbers of different bacteria were suppressed to 300 cells/g or less, and no harmful substance such as residual pesticide was detected.

Since proteins in the full fat partially-inactivated soy flour (D) of Example 1 are water-soluble proteins that are not denatured, they dissolved well in drinking water and hence had application as an instant soy beverage. When drinking the soy beverage, it has no grassy-smelling and good taste.

### Example 2

The raw soy flour (E) was obtained in a similar manner as Example 1 except that a step corresponding to the partially-inactivating steaming step 302 was not conducted. Componential analysis similar to that of Example 1 revealed that trypsin inhibitor which is a digestion inhibiting enzyme was not inactivated, and denaturation of available ingredients (nutrition composition) possessed by soybeans was little observed. Bacteria inspection revealed that the numbers of different bacteria were 300 cells/g or less, and no harmful substance such as residual pesticide was detected as is the same with Example 1.

Bean curd produced by using the full fat raw soy flours (E) of Example 2 was very delicious and kept for a long time.

### Example 3

The fully-inactivated soy flour (F) was obtained in a similar manner as Example 1 except that in place of the partially-inactivating steaming step 302, the sterile dehulled soybeans (C) were subjected to steaming by steam of 125° C. for 90 seconds using a commercially available steaming furnace (fully-inactivating steaming step 322). Componential analysis similar to that of Example 1 revealed that available ingredients (nutrition composition) were denatured to some degree, and all enzymes were inactivated. Bacteria inspection revealed that the numbers of different bacteria were 300 cells/g or less, and no harmful substance such as residual pesticide was detected, as is the same with Example 1.

The full fat fully-inactivated soy flour (F) is fully inactivated and deodorized, and hence the soybean is easy to handle, and can be utilized in various processed foods, and processed foods thereof kept for a long time.

### INDUSTRIAL APPLICABILITY

As described above, according to the present invention, great effects are provided that it is possible to provide sterile dehulled soybeans bearing bacteria of 300 cells/g or less; to provide a method for producing, using the sterile dehulled soybean, adequately sterilized full fat soy flour in which grassy-smelling characteristic of soybeans is removed (deodorized) without impairing available ingredients (nutrition composition) possessed by soybeans such as water-soluble proteins, and digestion and absorption rate is high due to inactivation of a digestion inhibiting enzyme; to provide a method for producing adequately sterilized full fat soy flour in which enzymes are alive; and to provide a method for producing adequately sterilized full fat soy flour in which all enzymes are inactivated.

1. (canceled)

2. A method for producing full fat soy flour, comprising:
(a) a sorting step where foreign matters are removed from starting soybeans to obtain sorted soybeans;
(b) a dehulling step where germs and hulls are removed from the sorted soybeans to obtain sterile dehulled soybeans;
(c) a partially-inactivating steaming step where the sterile dehulled soybeans are steamed for 60 to 300 seconds by hot water or steam heated at a temperature of 70 to 125° C. so as to deodorize the sterile dehulled soybeans and inactivate a digestion inhibiting enzyme;
(d) a desiccating step where the steamed sterile dehulled soybeans are desiccated to a predetermined water content;
(e) a pulverizing step where the desiccated sterile dehulled soybeans are pulverized; and
(f) a classifying step where the pulverized sterile dehulled soybeans are classified into only soy flour having a predetermined grain size or less.

3. A method for producing full fat soy flour, comprising:
(a) a sorting step where foreign matters are removed from starting soybeans to obtain sorted soybeans;
(b) a dehulling step where germs and hulls are removed from the sorted soybeans to obtain sterile dehulled soybeans;
(d) a desiccating step where the steamed sterile dehulled soybeans are desiccated to a predetermined water content;
(e) a pulverizing step where the desiccated sterile dehulled soybeans are pulverized; and
(f) a classifying step where the pulverized sterile dehulled soybeans are classified into only soy flour having a predetermined grain size or less.

4. A method for producing full fat soy flour, comprising:
(a) a sorting step where foreign matters are removed from starting soybeans to obtain sorted soybeans;
(b) a dehulling step where germs and hulls are removed from the sorted soybeans to obtain sterile dehulled soybeans;
(c1) a fully-inactivating steaming step where the sterile dehulled soybeans are steamed for 60 to 300 seconds by hot water or steam heated at a temperature of 85 to 150° C. so as to deodorize the sterile dehulled soybeans and inactivate all enzymes;
(d) a desiccating step where the steamed sterile dehulled soybeans are desiccated to a predetermined water content;
(e) a pulverizing step where the desiccated sterile dehulled soybeans are pulverized; and
(f) a classifying step where the pulverized sterile dehulled soybeans are classified into only soy flour having a predetermined grain size or less.
